(19) United States
(12) Patent Application Publication
(10) Pub. No.: US 2025/0330984 A1
(43) Pub. Date: Oct. 23, 2025

(54) SIDELINK REFERENCE SIGNAL FOR POSITIONING

(71) Applicant: Apple Inc., Cupertino, CA (US)

(72) Inventors: Chunxuan Ye, San Diego, CA (US); Chunhai Yao, Beijing (CN); Dawei Zhang, Saratoga, CA (US); Haitong Sun, Saratoga, CA (US); Hong He, San Jose, CA (US); Oghenekome Oteri, San Diego, CA (US); Seyed Ali Akbar Fakoorian, San Diego, CA (US); Wei Zeng, Saratoga, CA (US); Weidong Yang, San Diego, CA (US); Yushu Zhang, Beijing (CN)

(73) Assignee: Apple Inc., Cupertino, CA (US)

(21) Appl. No.: 18/860,568

(22) PCT Filed: Apr. 4, 2023
(86) PCT No.: PCT/US2023/017405

§ 371 Date: Oct. 25, 2024

Related U.S. Application Data
(60) Provisional application No. 63/336,223, filed on Apr. 28, 2022.

(51) Int. Cl. H04W 72/21; H04L 5/00

(52) U.S. Cl. CPC H04W 72/21; H04L 5/0051

(57) ABSTRACT

The present application relates to devices and components including apparatus, systems, and methods to configure and use reference signals for positioning in device-to-device communications (e.g., sidelink communications between two UEs). Configuration information can be generated for a device and can indicate sidelink resources in a resource pool configured to be used for a reference signal for positioning. In the time domain, the configuration can be at a slot level or a symbol level. The configured sidelink resources can be indexed in the time domain and the frequency domain. Control information can be transmitted to indicate a next transmission of a reference signal for positioning. This control information can implicitly or explicitly indicate a configured sidelink resource to be used in the next transmission.

### CROSS REFERENCE OF RELATED APPLICATION

This application is a 371 U.S. National Phase of PCT International Patent Application No. PCT/US2023/017405, filed Apr. 4, 2023, entitled “SIDELINK REFERENCE SIGNAL FOR POSITIONING,” which claims priority to U.S. Provisional Application No. 63/336,223, filed Apr. 28, 2022. The contents of this application are hereby incorporated by reference in their entireties for all purposes.

### BACKGROUND

Fifth generation mobile network (5G) is a wireless standard that aims to improve upon data transmission speed, reliability, availability, and more. This standard, while still developing, includes numerous details relating to using channels between devices, such as between base stations and user equipment (UE) or between UEs. In the latter case, a channel between UEs can be referred to as a sidelink channel.

### BRIEF DESCRIPTION OF THE DRAWINGS

FIG. 1 illustrates an example of a network environment, in accordance with some embodiments.

FIG. 2 illustrates an example of a resource pool usable for sidelink transmissions, in accordance with some embodiments.

FIG. 3 illustrates an example of a configuration for a sidelink reference signal for positioning (SL RSP), in accordance with some embodiments.

FIG. 4 illustrates another example of a configuration for an SL RSP, in accordance with some embodiments.

FIG. 5 illustrates yet another example of a configuration for an SL RSP, in accordance with some embodiments.

FIG. 6 illustrates a further example of a configuration for an SL RSP, in accordance with some embodiments.

FIG. 7 illustrates an example of resource indexing for an SL RSP, in accordance with some embodiments.

FIG. 8 illustrates another example of resource indexing for an SL RSP, in accordance with some embodiments.

FIG. 9 illustrates an example of a resource allocation for an SL RSP, in accordance with some embodiments.

FIG. 10 illustrates an example of a time gap between a sidelink transmission and an SL RSP transmission, in accordance with some embodiments.

FIG. 11 illustrates an example of an operational flow/algorithmic structure for an SL RSP transmission, in accordance with some embodiments.

FIG. 12 illustrates an example of an operational flow/algorithmic structure for an SL RSP reception, in accordance with some embodiments.

FIG. 13 illustrates an example of receive components, in accordance with some embodiments.

FIG. 14 illustrates an example of a UE, in accordance with some embodiments.

FIG. 15 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a first device can communicate with a second device in a device-to-device communication scheme. This type of communication can occur over a sidelink channel, referred to in 5G cellular networks as a physical sidelink shared channel (PSSCH) that carries data or a physical sidelink control channel (PSCCH) that carries control information. The first device can send a sidelink reference signal for positioning (abbreviated herein as “SL RSP” where “S” refers to sidelink and “RSP” refers to reference signal for positioning”). The second device can perform one or more measurements on the SL RSP to determine a position (e.g., the position of the second device or that of the first device).

To enable the device positioning using SL RSP transmissions and measurements, sidelink resources of the sidelink channel (e.g., of the PSSCH and/or the PSCCH) can be initially configured as being usable for SL RSP. Subsequently, sidelink control information (SCI) can be transmitted from the first device prior to an SL RSP transmission such that the second device can receive the transmitted SL RSP using the configured sidelink resources.

In an example, sidelink resources are configured for the SL RSP (e.g., by the first device), where these resources can include slots of the sidelink channel and/or symbols within one or more of such slots that are usable for the SL RSP. In the frequency domain, the sidelink resources can occupy combed resource elements and can be distributed along the whole bandwidth of the sidelink channel or a portion of the bandwidth. The resource elements can be indexed frequency first and time second or vice versa.

In an example, SCI can explicitly indicate the sidelink resources allocated for the next SL RSP transmission. Alternatively, the SCI can explicitly indicate PSSCH and/or the PSCCH resources and implicitly indicate the sidelink resources for the next SL RSP transmission. This implicit indication can depend on the explicit indication of the PSSCH and/or the PSCCH resources.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE may have a primary function of communication with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

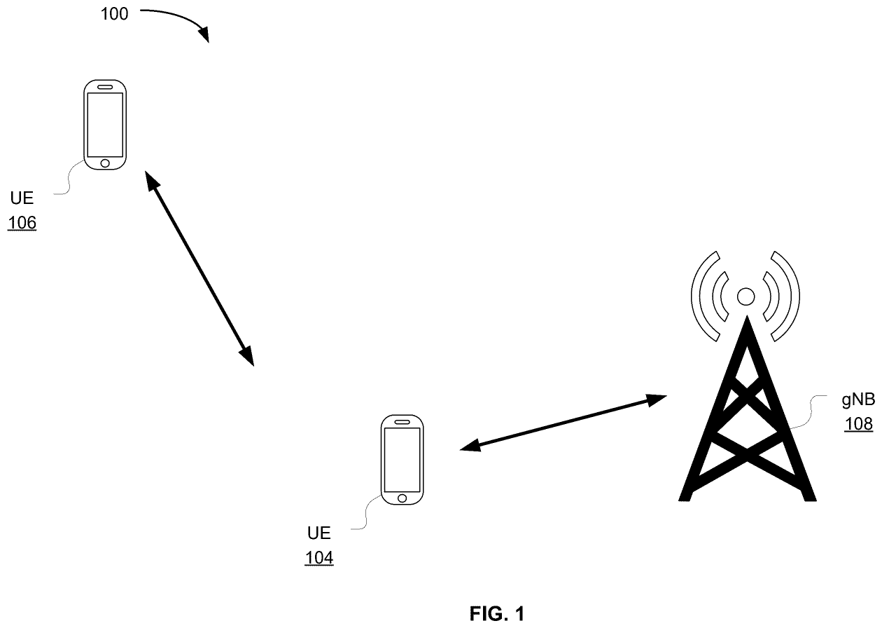

FIG. 1 illustrates a network environment 100, in accordance with some embodiments. The network environment 100 may include a UE 104 and a gNB 108. The gNB 108 may be a base station that provides a wireless access cell, for example, a Third Generation Partnership Project (3GPP) New Radio (NR) cell, through which the UE 104 may communicate with the gNB 108. The UE 104 and the gNB 108 may communicate over an air interface compatible with 3GPP technical specifications, such as those that define Fifth Generation (5G) NR system standards.

The gNB 108 may transmit information (for example, data and control signaling) in the downlink direction by mapping logical channels on the transport channels, and transport channels onto physical channels. The logical channels may transfer data between a radio link control (RLC) and MAC layers; the transport channels may transfer data between the MAC and PHY layers; and the physical channels may transfer information across the air interface. The physical channels may include a physical broadcast channel (PBCH), a physical downlink control channel (PDCCH), and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure (including cell selection and reselection) and for beam selection.

The PDSCH may be used to transfer end-user application data, signaling radio bearer (SRB) messages, system information messages (other than, for example, MIB), and paging messages.

The PDCCH may transfer DCI that is used by a scheduler of the gNB 108 to allocate both uplink and downlink resources. The DCI may also be used to provide uplink power control commands, configure a slot format, or indicate that preemption has occurred.

The gNB 108 may also transmit various reference signals to the UE 104. The reference signals may include DMRSs for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include channel status information reference signals (CSI-RS). The CSI-RS may be a multi-purpose downlink transmission that may be used for CSI reporting, beam management, connected mode mobility, radio link failure detection, beam failure detection and recovery, and fine tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain and one orthogonal frequency division multiplexing (OFDM) symbol in the time domain. Twelve consecutive subcarriers in the frequency domain may compose a physical resource block (PRB). A resource element group (REG) may include one PRB in the frequency domain and one OFDM symbol in the time domain, for example, twelve resource elements. A control channel element (CCE) may represent a group of resources used to transmit PDCCH. One CCE may be mapped to a number of REGs, for example, six REGs.

The UE 104 may transmit data and control information to the gNB 108 using physical uplink channels. Different types of physical uplink channels are possible including, for instance, a physical uplink control channel (PUCCH) and a physical uplink shared channel (PUSCH). Whereas the PUCCH carries control information from the UE 104 to the gNB 108, such as uplink control information (UCI), the PUSCH carries data traffic (e.g., end-user application data) and can carry UCI.

The UE 104 and the gNB 108 may perform beam management operations to identify and maintain desired beams for transmission in the uplink and downlink directions. The beam management may be applied to both PDSCH and PDCCH in the downlink direction, and PUSCH and PUCCH in the uplink direction.

In an example, communications with the gNB 108 and/or the base station can use channels in the frequency range 1 (FR1) band, frequency range 2 (FR2) band, and/or high frequency range (FRH) band. The FRI band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device should apply a clear channel assessment (CCA) check before using the channel.

As further illustrated in FIG. 1, the network environment 100 may further include another UE 106, with which the gNB 108 can connect in a similar manner as the gNB 108-UE 104 connection. The UE 104 can also connect to UE 106 by using sidelink channels. These sidelink channels can include a PSSCH and a PSCCH. PSSCH can be analogous to PDSCH and can carry data in a one-to-one or one-to-many scheme. In other words, UE 104 can be a transmitter device that transmits data to one or more devices (including UE 106) on the PSSCH or can be a receiver device in a set of devices that receive data from the UE 106 on PSSCH. PDSCH can be analogous to PDCCH and can carry sidelink control information (SCI). SCI is similar to DCI and includes information about the resource allocation of the PSSCH.

In the use case of sidelink channels, a transmitter device can represent a UE that sends SCI to a receiver device, where the receiver device can represent another UE that receives the SCI. The transmitter device can also transmit an SL RSP that the receiver device receives and performs measurements on to determine a position of the receiver device or the transmitter device. In the interest of clarity of explanation, such transmitter device and receiver device are described herein as transmitter UE (e.g., the UE 104) and a receiver UE (e.g., the UE 106), respectively. The transmitter and receiver devices can be any type of devices capable of supporting at least sidelink communications and can include any or a combination of mobile cellular devices, vehicle to everything (V2X) devices, public safety devices, commercial devices, industrial internet of things (IIOT) devices, and the like.

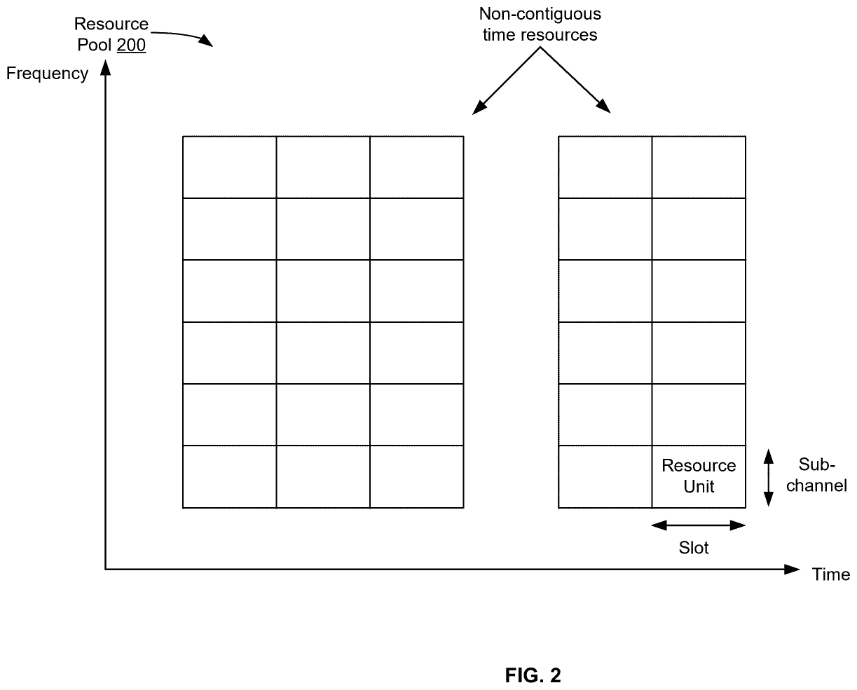

FIG. 2 illustrates an example of a resource pool 200 usable for sidelink transmissions, in accordance with some embodiments. This resource pool 200 illustrated from the perspective of a transmitter device (e.g., UE 104) that configures a resource pool for a receiver device (e.g., UE 106), where this resource pool 200 includes resource units usable to carry SL RSP. However, this resource pool 200 equivalently applies to the receiver device.

Generally, a resource pool is a set of resources defined in the time domain and frequency domain. In the time domain, the resources use a number of slots. The slots may but need not be contiguous (FIG. 2 illustrates non-contiguous slots). Each slot can include a number of symbols (such symbols are further illustrated in the next figures). The slots can be repeated according to a particular periodicity (e.g., 10,240 ms). The slots can generally be referred to as physical slots, in which case the physical slots include sidelink and non-sidelink slots (e.g., the non-sidelink slots being slots that do not belong to the resource pool 200). The slots that belong to the resource pool 200 (e.g., the sidelink slots) can be referred to as logical slots. A bitmap can be used to indicate the logical slots within a time period and the bitmap's applicability can be repeated depending on the periodicity. The bitmap can have a length of ten, eleven, . . . one-hundred sixty bits, or some other length depending at least on the number of slots.

In the frequency domain, the resources use a number of sub-channels. Generally, the sub-channels are contiguous. Each subchannel includes a number of subcarriers (e.g., one-hundred twenty subcarriers, each 15 kHz or larger).

As illustrated in FIG. 2, in both the time domain and the frequency domain, a resource corresponds to a resource unit (e.g., one time slot and one sub-channel unit). The resource unit can include a number of resource elements, where each resource element corresponds to a single orthogonal frequency division (OFDM) symbol in the time domain and a single subcarrier in the frequency domain.

The transmitter device can configure the resource pool 200 to the receiver device. Some of the configured resources can be used for PSSCH and/or PSCCH transmissions. As used herein, a sidelink channel refers to any or a combination of the PSSCH and PSCCH. PSSCH and/or PSCCH can be abbreviated herein as PSSCH/PSCCH or sidelink channel. Some of the configures resources can also be used for the transmission of SL RSP by the transmitter device and for reception of the SL RSP by the receiving device. The SL RSP can be a reference signal sent by the transmitter device to the receiver device on the sidelink channel (e.g., by using the relevant resources of the resource pool 200) for positioning purposes. Additionally or alternatively, the SL RSP can be a reference signal sent from the receiver device to the transmitter device on the sidelink channel for positioning purposes (e.g., similar to a sounding reference signal (SRS) sent on PUSCH or PUCCH).

Embodiments of the present disclosure involve various techniques for configuring the resource pool 200 such that resources are usable for the SL RSP transmission, indexing such resources, and indicating the resource allocation (e.g., via SCI). In one example, in the time domain, the resources can be configured at a slot granularity level and/or at a symbol granularity level, where the resource could be a repurposed PSSCH/PSCCH resource or a resource usable for the sidelink channel but not already included in the resource pool 200. In the frequency domain, a resource using a sub-channel can use multiple subcarriers of the sub-channel (e.g., in a combed fashion) and can span the entire bandwidth or a portion of the bandwidth. As such, this resource can include multiple resource elements (in the time and frequency domains) and these resource elements can be indexes frequency first and time second or time first and frequency second. The SCI can explicitly or implicitly indicate the resources of the resource pool 200 that are scheduled for the SL RSP transmission. These and other features are further described in the next figures.

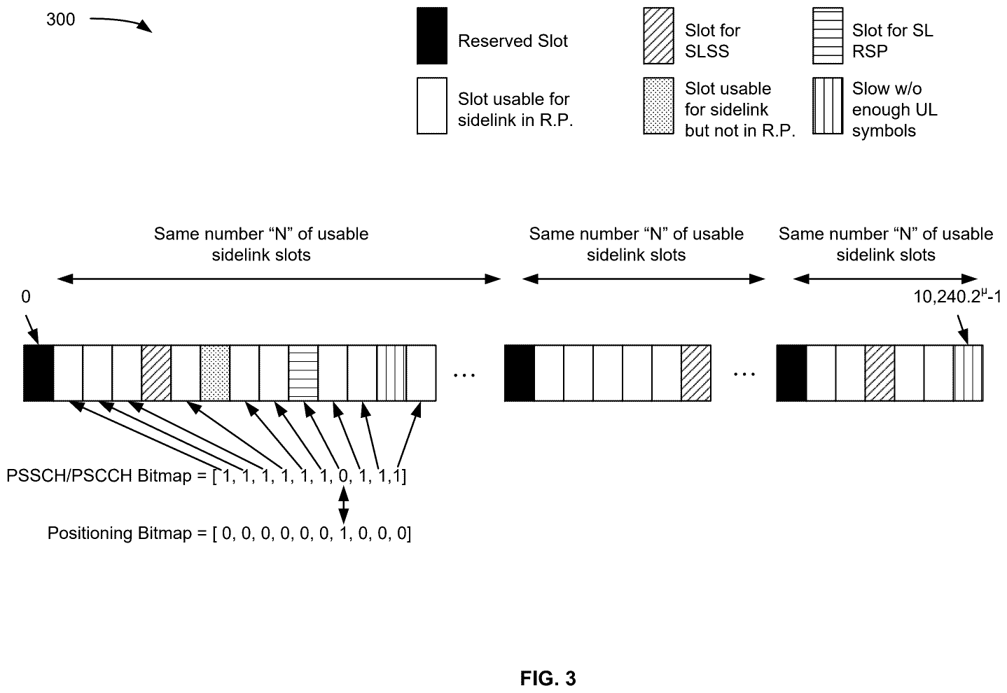

FIG. 3 illustrates an example of a configuration 300 for an SL RSP, in accordance with some embodiments. In this illustration, a single sub-channel in the frequency domain and multiple slots are shown in the time domain. The number of slots is 10,240·2^{μ}, where “μ” is the numerology. The same number “N” of usable slots for a sidelink channel repeats so that a resource pool can have a certain periodicity (10,240 ms in the illustration of FIG. 3). The slots can be indexed using a system frame number (SFN) or a direct frame number (DFN), where the first slot is indexed “0” and the last slot is indexed “10,240·2^{μ}−1.”

The resource pool includes different slots except for slots usable for sidelink synchronization signals (SLSS) (illustrated with diagonally to the left dashed rectangles), slots without enough uplink symbols (illustrated with vertically dashed rectangles), and reserved slots (illustrated with solid dark rectangles). The number of SLSS slots is N_{S}_{_{SSB}}. The number of slots not having enough uplink symbols is N_{nonSL} and includes slots not having at least Y-th, (Y−1)-th, . . . , (Y+X−1)-th symbols in a slot semi-statically for uplink as indicated in TDD-UL-DL-ConfigCommon, where “X” is a configured number of symbols per sidelink slot, and “Y” is a sidelink starting symbol index in a slot. The number of reserved slots is N_{reserved}=10,240·2^{μ}−N_{S}_{_{SSB}}−N_{nonSL})mod L_{bitmap} and such slots are typically distributed evenly across each resource period.

Remaining slots are slots usable for sidelink and are either included in or excluded from the resource pool. A first bitmap (illustrated as a PSSCH/PSCCH bitmap) indicates whether such slots are included in or excluded from the resource pool. In particular, each bit in the bitmap corresponds to one of these slots, and the bit value of this bit indicates the inclusion (e.g., when the bit value is “1”) or the exclusion (e.g., when the bit value is “0”). In the illustration of FIG. 3, the first bitmap includes ten bits. The bit values of the first six bits and the last three bits is set to “1” and the bit value of the seventh bit is set to “0.” As such, the bitmap indicates that the first six slots and the last three slots usable for sidelink (their indexes being defined relatively to the SFN or DFN and not the bit locations in the first bitmap) are included in the resource pool, whereas the seventh slot is excluded from the resource pool. The slots included in the resource pool and usable for PSSCH/PSCCH are shown with blank rectangles.

In an example, the configuration 300 is at a slot level and indicates that a resource that is usable for sidelink but that was excluded from the resource pool is now included in the resource pool for the purpose of SL RSP transmission. In other words, this resource is a dedicated slot for the SL RSP transmission. Multiple dedicated slots can be allocated for the SL RSP and can be configured separately from the PSSCH/PSCCH resources (the resources that correspond to the blank rectangles). For instance, the configuration 300 can include first configuration information specific to the PSSCH/PSCCH resources and second configuration information specific to the SL RSP. The first configuration information can include the first bitmap, whereas the second configuration can include a second bitmap (illustrated as a positioning bitmap). The second bitmap includes bits indicating whether slots usable for sidelink are included in the resource pool for the purpose of SL RSP transmission. Given that a slot can be dedicated for the SL RSP transmission, this slot would not be usable for PSSCH/PSCCH resources. As such, bit values of the second map cannot conflict with bit values of the first bitmap. In particular, if the first bitmap indicates that a slot is usable for sidelink (e.g., for a PSSCH/PSCCH transmission) and is included in the resource pool (e.g., by using a bit value of “1” for the corresponding bit in the first bitmap), the second bitmap indicates that this slot is not usable for the SL RSP transmission (e.g., by using a bit value of “0” for the corresponding bit of the second bitmap). In comparison, if the first bitmap indicates that a slot is usable for sidelink (e.g., for a PSSCH/PSCCH transmission) and is excluded from the resource pool (e.g., by using a bit value of “0” for the corresponding bit in the first bitmap), the second bitmap indicates that this slot is either (i) usable for the SL RSP transmission (e.g., by using a bit value of “1” for the corresponding bit of the second bitmap) and thus is included in the resource pool, or (ii) is not usable for the SL RSP transmission (e.g., by using a bit value of “0” for the corresponding bit of the second bitmap) and thus remains excluded from the resource pool. However, the second bitmap cannot indicate that a slot is usable for the SL RSP when the first bitmap indicates that this same slot is included in the resource pool (e.g., both bitmaps setting the bit values of the corresponding bits to the same bit value of “1”).

In the illustration of FIG. 3, the first bitmap indicates that the seventh slot usable for sidelink is excluded from the resource pool (e.g., the corresponding seventh bit having a value of “0”). In comparison, the second bitmap indicates that this seventh slot included in the resource pool for use in the SL RSP transmission (e.g., the corresponding seventh bit having a value of “1”). This SL RSP slot is illustrated with a horizontally dashed rectangle. Conversely, the first bitmap indicates that the remaining nine slots usable for sidelink are included in the resource pool (e.g., the corresponding nine bits having a value of “1”), whereas the second bitmap indicates that these nine slots are not to be used in the SL RSP transmission.

In an example of the dedicated slots for SL RSP transmission being configured separately from the PSSCH/PSCCH resources, the configuration 300 includes resource pool configuration “sl-ResourcePool.” In turn, this resource pool configuration includes the first and second bitmaps as a “sl-TimeResource” and as an “sl-TimeResourcePositioning,” respectively. In the bitmap “sl-TimeResourcePositioning,” a bit value of “0” indicates that the corresponding slot is not used by sidelink reference signals for positioning, and a bit value of “1” indicates that the corresponding slot is used by sidelink reference signals for positioning. The bitmap “sl-TimeResourcePositioning” may have the same length as the bitmap “sl-TimeResource,” where the position with value “1” in the “sl-TimeResourcePositioning” may correspond to the position with value “0” in the “sl-TimeResource.”

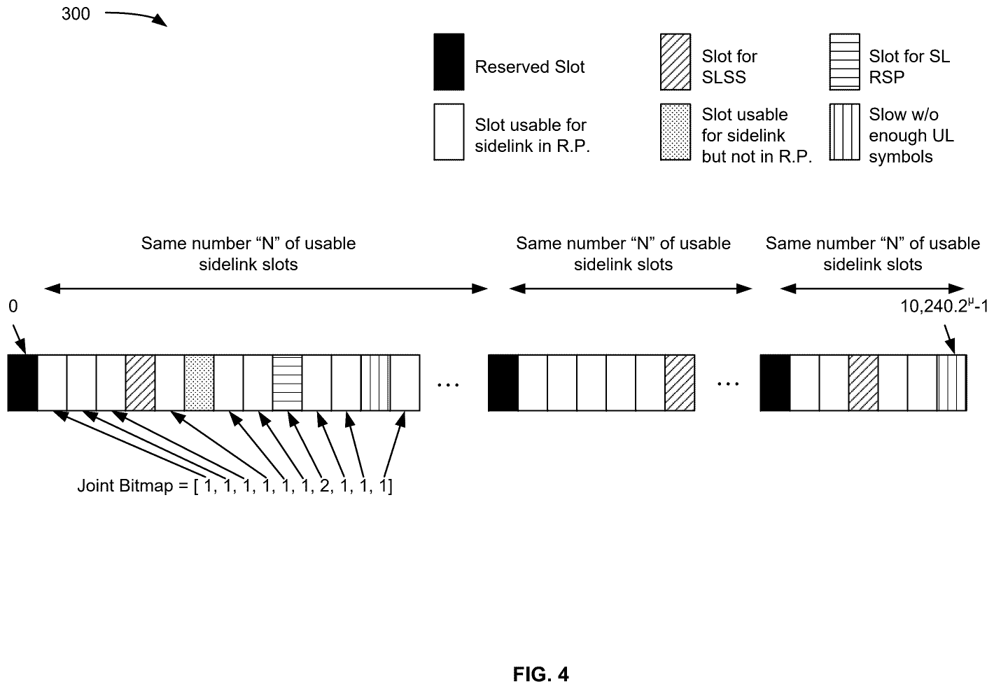

FIG. 4 illustrates another example of a configuration 400 for an SL RSP, in accordance with some embodiments. The illustration of FIG. 4 shows different slots that can be included or excluded from a resource pool. These types of slots are similar to the slots described in FIG. 3. Similarities are not repeated herein in the interest of brevity. However, the description of these slots equivalently applies to FIG. 4.

Whereas the configuration 300 configures the resources for SL RSP transmission separately from the configuring of the PSSCH/PSCCH resources, here the configuration 400 jointly configures the resources for SL RSP transmission and the PSSCH/PSCCH resources. For instance, rather than using two separate bitmaps, a single bitmap is used (illustrated herein as a joint bitmap). The bits of this bit map can use trinary values (instead of binary values as in FIG. 3): a value of “0” indicates that a slot usable for sidelink is excluded from a resource pool, a value of “1” indicates that a slot usable for sidelink is included in the resource pool for a PSSCH/PSCCH transmission, and a value of “2” indicates that a slot usable for sidelink is included in the resource pool for a SL RSP transmission.

In the illustration of FIG. 4, the joint bitmap indicates that the first six slots usable for sidelink and the last three slots usable for sidelink are included in the resource pool as PSSCH/PSCCH slots (e.g., the corresponding bits have a value of “1”). Further, the joint bitmap indicates that the seventh slot usable for sidelink is included in the resource pool as an SL RSP slot (e.g., the corresponding bit has a value of “2”).

In an example of the dedicated slots for SL RSP transmission, the dedicated slots are jointly configured with PSSCH/PSCCH resources. In this example, the configuration 400 includes a resource pool configuration “sl-ResourcePool.” In turn, this resource pool configuration includes a bitmap “sl-TimeResource” modified from a bit string to a trinary string, where “0” indicates the corresponding slot is used by sidelink, “1” indicates that the corresponding slot is used for PSSCH/PSCCH, and “2” indicates that the corresponding slot is used for sidelink reference signals for positioning.

In FIGS. 3 and 4, a slot level configuration is used to indicate that a slot is included in the resource pool for PSSCH/PSCCH and is dedicated for a SL RSP transmission. Other variations exist. For instance, a slot level configuration can be used and can be separate from the resource pool for PSSCH/PSCCH. In particular, slots can be dedicated for sidelink reference signals for positioning. These dedicated slots are not included in the PSSCH/PSSCH resources (similarly to the reserved slots, SLSS slots, and slots without enough uplink symbols being excluded from the PSSCH/PSSCH resource pool). Instead, the dedicated slots may be configured with a fixed periodicity (e.g., a 160 ms period), similar to a sidelink synchronization signal block (SL SSB). For instance, an “SL-RSP-TimeAllocation” can be configured similarly to the way a “SL-SSB-TimeAllocation” is configured.

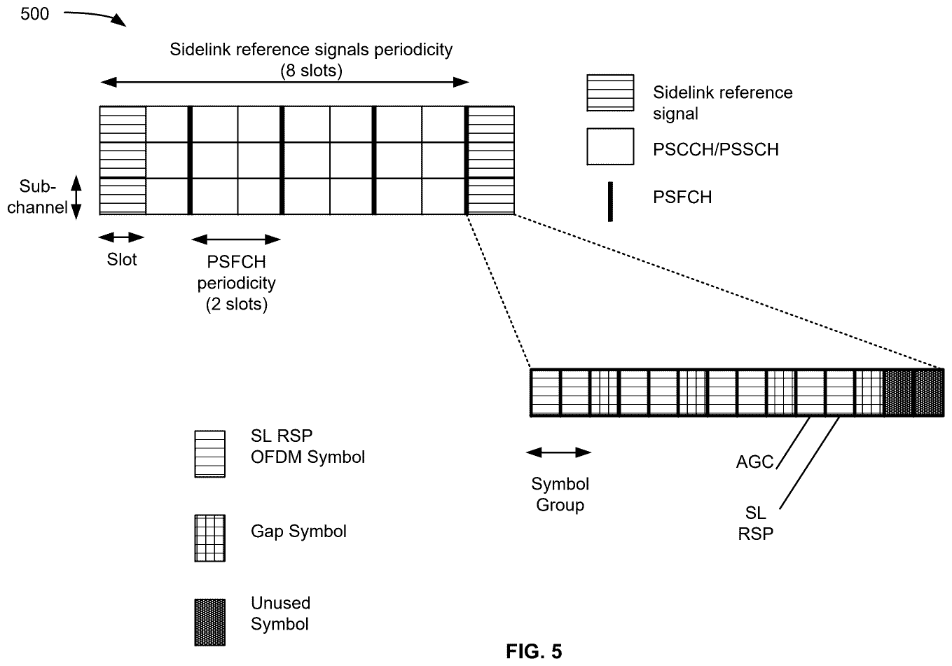

FIG. 5 illustrates yet another example of a configuration 500 for an SL RSP, in accordance with some embodiments. Here, the configuration 500 indicates that slots are dedicated for sidelink reference signals for positioning and are included in the PSSCH/PSCCH resources (similar to the configuration 300 or 400). This slot level configuration is illustrated in the top left hand side of FIG. 5. However, within a dedicated slot, the configuration 500 further indicates symbols configured for the sidelink reference signals. This symbol level configuration is illustrated in the bottom right hand side of the figure.

Starting with the slot level configuration, nine slots per sub-channel are illustrated, and three sub-channels are also illustrated. The resources dedicated for an SL RSP transmission are shown with the horizontally dashed rectangles, whereas the resources that are used for PSSCH/PSCCH are shown with blank rectangles. Some symbols of the slots with PSSCH/PSCCH resources can be used for a physical sidelink feedback channel (PSFCH). For instance, the last two symbols in a slot with PSSCH/PSCCH resource include PSFCH symbols (shown with solid dark rectangles). The PSFCH symbols can be configured with a particular PSFCH periodicity (e.g., to repeat every two slots). The SL RSP slots can also have an SL RSP periodicity (e.g., to repeat every eight slots). An offset (although not illustrated in FIG. 5) can also be configured for the SL RSP slots. In other words, periodicity and offset are configured, in the configuration 500, for SL RSP.

In an example, if a PSSCH/PSCCH slot includes at least one PSFCH symbol, this slot cannot be repurposed to be used as dedicated SL RSP slot. For instance, if the SL RSP periodicity is eight slots, the PSFCH periodicity is two slots, and an offset of zero is used, an SL RSP slot can overlap with a PSSCH/PSCCH slot that includes a PSFCH symbol. In this case, this PSSCH/PSCCH slot is not repurposed to be used for an SL RSP transmission. Alternatively, the repurposing of the PSSCH/PSCCH symbols to SL RSP symbols is allowed, whereby the PSFCH symbol(s) are also repurposed for use as SL RSP symbols or the PSFCH symbol(s) are not repurposed.

Referring now to the symbol level configuration, a slot dedicated to SL RSP (e.g., an SL RSP slot) includes a number of OFDM symbols (e.g., fourteen). In this SL RSP slot, every “X” consecutive OFDM symbols define a symbol group and can be used for SL RSP. In the illustration of FIG. 5, “X” is equal to two, although a different number is possible. Each symbol group can be associated with a transmitter device-receiver device pair (e.g., different symbol groups can be used by different device pairs in a time division multiplexing manner). The same content can be repeated in the OFDM symbol group. The first OFDM symbol (or the first “Y” number of such symbols, where “Y” is strictly smaller than “X”) can be used for automatic gain control (AGC). The remaining OFDM symbols of the OFDM symbols can be used for positioning purposes (e.g., as actual SL RSP symbols). The number “X” and/or the number “Y” can be predefined or can be configured per resource pool (e.g., indicated in the configuration information that defines the configuration 500). As such, SL RSP resource are arranged, in the time domain, in OFDM symbol groups, and each of the symbol groups is usable for a device pair (although multiple symbol groups in the same SL RSP slot can be used by the same device pair). A number “Z” of gap symbols (“Z” is equal to one in the illustration of FIG. 5, shown with grid patterned rectangles) can be used, where the “Z” gap symbol(s) separate two symbol groups (e.g., are positioned between the end of the first symbol group and the start of the second symbol group). Here also the value of “Z” can be predefined or configured for the resource pool. The “Z” gap symbol(s) are used for transmit-receive transitions (e.g., for radio frequency RF circuitry transitioning between a transmit chain and a receive chain, or vice versa, similar to the use of measurement gaps). In certain situations, some of the symbols within the SL RSP slot may remain unused (not purposed for SL RSP or as gap symbols.) These symbols are illustrated with the solid dark rectangles patterned with blank dots (the last two right symbols in the illustrated slot). In an example, these unused symbols may, but need not, be repurposed for non-SL RSP uses (e.g., as PSSCH/PSCCH symbols or PSFCH symbols). The configuration with the SL RSP slot can be repeated across the other SL RSP slots (e.g., the symbol configuration can be repeated every eight slots in the illustration of FIG. 5).

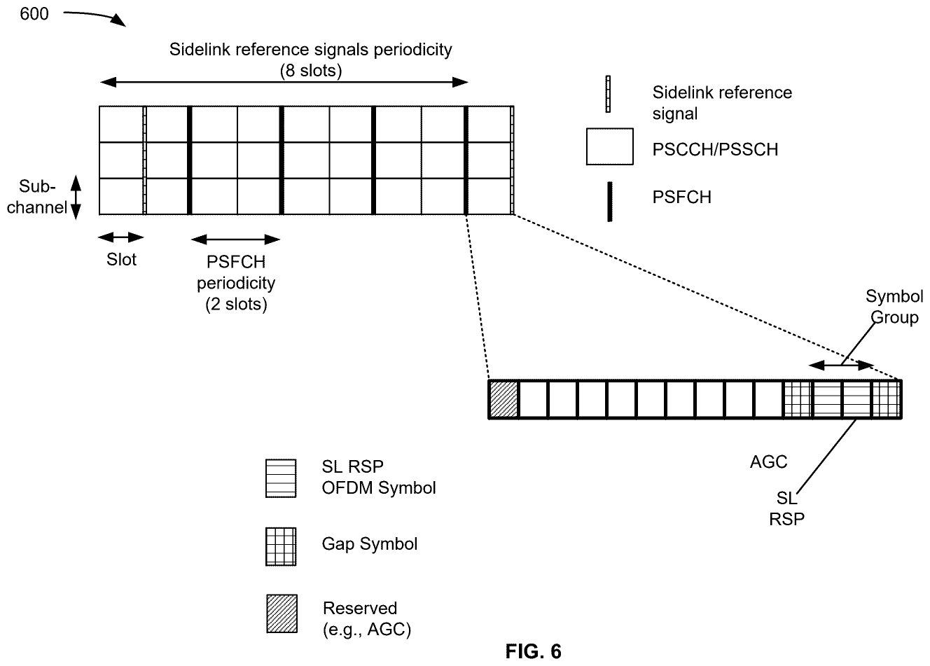

FIG. 6 illustrates a further example of a configuration 600 for an SL RSP, in accordance with some embodiments. Here, dedicated slots included in PSSCH/PSCCH resources are used for SL RSP. However, rather than using an entire dedicated slot, only a portion (e.g., a number of symbols) are used for SL RSP. The top left hand side of FIG. 6 shows the slot level configuration, whereas the bottom right hand side of FIG. 6 shows the symbol level configuration.

Starting with the slot level configuration, nine slots per sub-channel are illustrated, and three sub-channels are also illustrated. The resources dedicated for PSSCH/PSCCH are shown as blank rectangles. Some of these PSSCH/PSCCH resources are dedicated to be used for SL RSP. In particular, each of such PSSCH/PSCCH resources includes a set of SL RSP symbols. The SL RSP symbols can be configured with a particular SL RSP periodicity (e.g., to repeat every eight slots) and are shown with horizontally dashed rectangle. Other ones of the PSSCH/PSCCH are also dedicated to be used for PSFCH. In particular, each of such PSSCH/PSCCH resources includes a set of PSFCH symbols. For instance, the last two symbols in such PSSCH/PSCCH resources are used for the PSFCH (shown with solid dark rectangles). The PSFCH symbols can be configured with a particular PSFCH periodicity (e.g., to repeat every two slots). In addition to the SL RSP periodicity, the configuration 600 can include an offset for the SL RSP.

In an example, a first set of PSSCH/PSCCH slots includes SL RSP symbols while a second set of PSSCH/PSCCH slots includes PSFCH symbols. In other words, SL RSP resources may share with PSFCH resources in a time division multiplexing manner (e.g., some PSSCH/PSCCH slots correspond to PSFCH resources while other PSSCH/PSCCH slots correspond to SL RSP resources).

Further, across different sub-channels or sub-carriers within a same sub-channel, SL RSP resources may share with PSFCH resources in a frequency division multiplexing manner (e.g., symbols have the same symbol index in the time domain can be used for SL RSP and PSFCH depending on the subcarriers and/or sub-channels, such that these shared resources overlap in the time domain and are frequency division multiplexed in the frequency domain). For instance, the SL RSP may copy some resource blocks (RBs) which are not used by the PSFCH.

In an example, if a PSSCH/PSCCH slot includes at least one PSFCH symbol, this slot cannot be repurposed to include an SL RSP symbol. For instance, if the SL RSP periodicity is eight slots, the PSFCH periodicity is two slots, and an offset of zero is used, an SL RSP symbol can overlap with a PSFCH symbol. In this case, the PSSCH/PSCCH slot that contains the overlap may not repurposed to be used for an SL RSP transmission (e.g., it would still be used for PSSH/PSCCH transmission and PSFCH transmission). Alternatively, the repurposing of the PSSCH/PSCCH symbols to SL RSP symbols is allowed, whereby the PSFCH symbol(s) are also repurposed for use as SL RSP symbols. In other situations (e.g., depending on the SL RSP periodicity and offset and on the PSFCH periodicity), a PSSCH/PSCCH slot can contain both SL RSP symbols and PSFCH symbols in a non-overlapping manner. In such situations, SL RSP resources may share with PSFCH resources in a time division multiplexing manner.

Referring now to the symbol level configuration, a PSSCH/PSCCH slot includes a number of OFDM symbols (e.g., fourteen). When this PSSCH/PSCCH slot does not contain PSFCH symbol it can contain “X” consecutive OFDM symbols that define a symbol group and can be used for SL RSP. In the illustration of FIG. 5, “X” is equal to two and these two symbols are located near the end of the PSSCH/PSCCH slot (e.g., the last two symbols before the last one), although a different number of symbols is possible and/or location are possible. The first “Y” symbols (e.g., “Y” is equal to one in FIG. 6) of the symbol group can be used for AGC and the remaining symbol(s) of the symbol group can be used for SL RSP. The content of the symbols is repeated across the symbols of the symbol group. Although a single symbol group is illustrated, multiple of such symbol groups can also be possible and, if two of such symbol groups are adjacent, they can be separated by “X” gap symbols. Nonetheless, the PSSCH/PSCCH also includes a number of OFDM symbols used as part of the PSSCH/PSCCH resources. The PSSCH/PSCCH symbols and the SL RSP symbol group are separated by “X” gap symbols. In the illustration of FIG. 6, “X” is equal to one, although a different number is possible. The last “X” symbol(s) of the PSSCH/PSCCH slot can also be gap symbol(s). The first symbol (or the first “Z” symbols) of the PSSCH/PSCCH can be reserved (e.g., used for AGC).

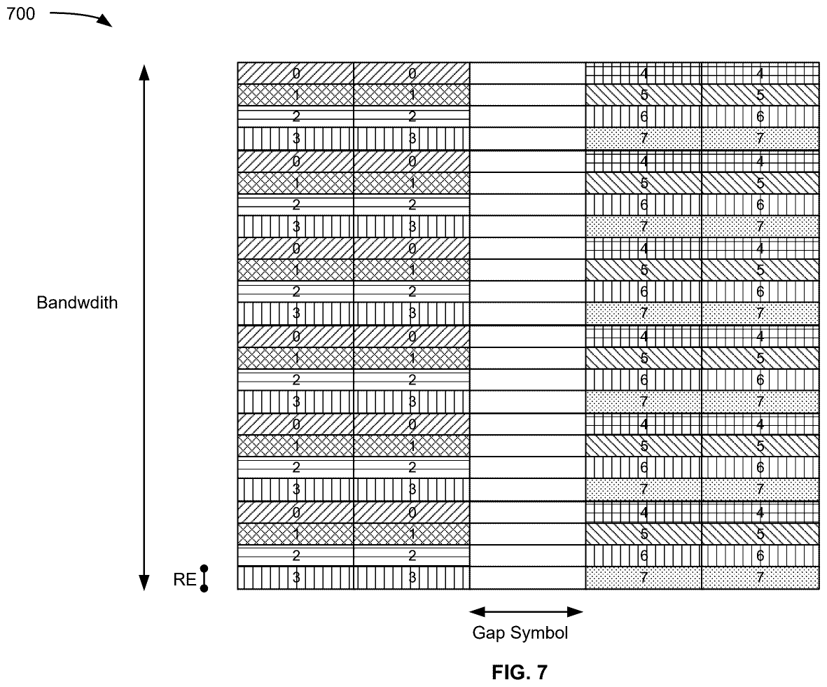

FIG. 7 illustrates an example of resource indexing 700 for SL RSP, in accordance with some embodiments. As explained herein above, resources can be configured for SL RSP (referred to herein as SL RSP resources). In the time domain, an SL RSP resources can occupy an entire slot or particular symbols within the slot. In the frequency domain, the SL RSP resource can occupy an entire sub-channel or a particular set of sub-carriers. FIG. 7 illustrates one example, where the SL RSP occupies two symbols in the time domain and combed resource elements (REs) each corresponding to a subcarrier and the collection of such REs spanning a bandwidth allocated to a sidelink channel.

In the particular illustration of FIG. 7, five symbols within a slot are shown in the time domain. Also, twenty-four subcarriers within a sub-channel (e.g., two resource blocks) are shown in the frequency. Of course, a different number of symbols and/or bandwidth are possible. Eight symbol groups are defined (shown with the different shading of the rectangles and with their respective indices). Each symbol group includes two OFDM symbols and is allocated to a device pair. Two symbol groups using a same subcarrier are separated by a gap symbol (for time division multiplexing, where four sets of symbol groups are multiplexed in the time domain, each set containing two symbol groups). A comb of four is used for each symbol group for frequency division multiplexing, where two sets of symbol groups are multiplexed in frequency time domain, each set containing four symbol groups.

As such, in the time domain, each SL RSP may occupy one or more symbols (the illustration of FIG. 7 supports eight SL RSPs). For instance, SL RSP “0” uses two OFDM symbols, indexed “0” and “0.” Although contiguous OFDM symbols are shown in FIG. 7, non-contiguous OFDM symbols are possible.

In the frequency domain, each SL RSP may occupy combed REs in an OFDM symbol. For instance, SL RSP “0” uses six combed REs per OFDM symbol (for a total of twelve combed REs for its symbol group of two OFDM symbols), with a comb equal to four. In the illustration of FIG. 7, each SL RSP occupies the whole bandwidth.

Further, FIG. 7 shows that an SL RSP resource is indexed with frequency first and time second (e.g., the resource of SL RSP “0” that includes two OFDM symbols forming an OFDM symbol group and six combed REs per OFDM symbol is indexed “0,” whereas the resource of the next SL RSP “1” that occupies the next set of REs and uses the same symbol indexes is indexed “1,” and so on). However, SL RSP resources can be indexed time first and frequency second.

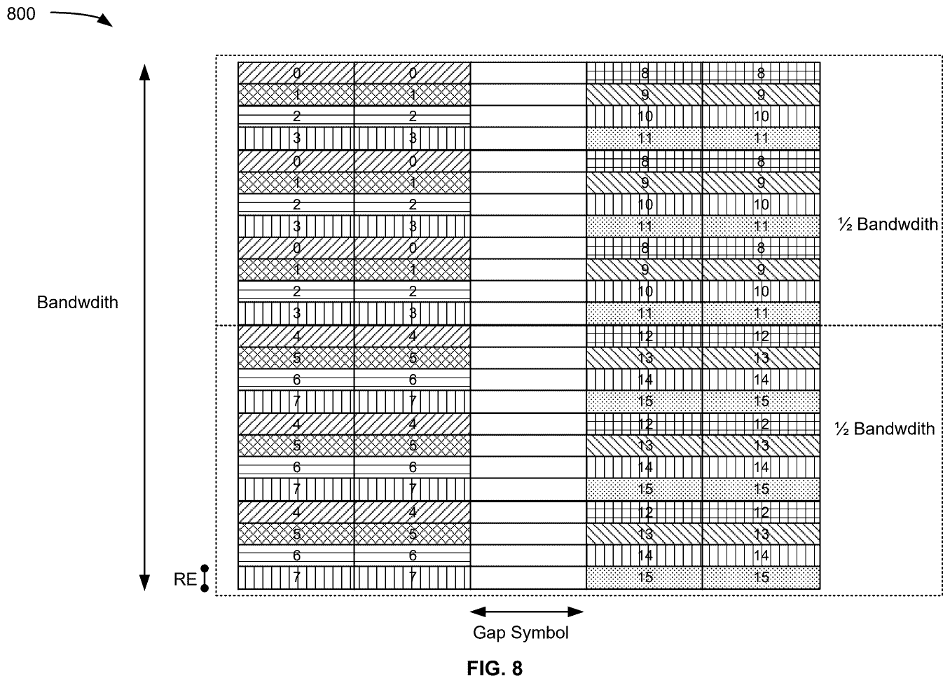

FIG. 8 illustrates another example of resource indexing 800 for an SL RSP, in accordance with some embodiments. The resource indexing 800 is similar to the resource indexing 700 of FIG. 7. Similarities are not repeated herein in the interest of brevity. However, the description of the resource indexing equivalently applies to FIG. 8. The difference is that, in the frequency domain, each SL RSP occupies a partial bandwidth (e.g., a portion, like a half, a quarter, or some other portion of the bandwidth of a sidelink channel).

In the particular illustration of FIG. 8, each SL RSP occupies half the bandwidth. As such, in the time domain, each SL RSP occupies two OFDM symbols. In the time domain, each SL RSP uses three combed REs per OFDM symbols (unlike FIG. 7, where six REs are used per OFDM symbol), with a comb equal to four. As such, sixteen SL RSP are indexed, each using a symbol group of two OFDM symbols and three combed REs per OFDM symbol.

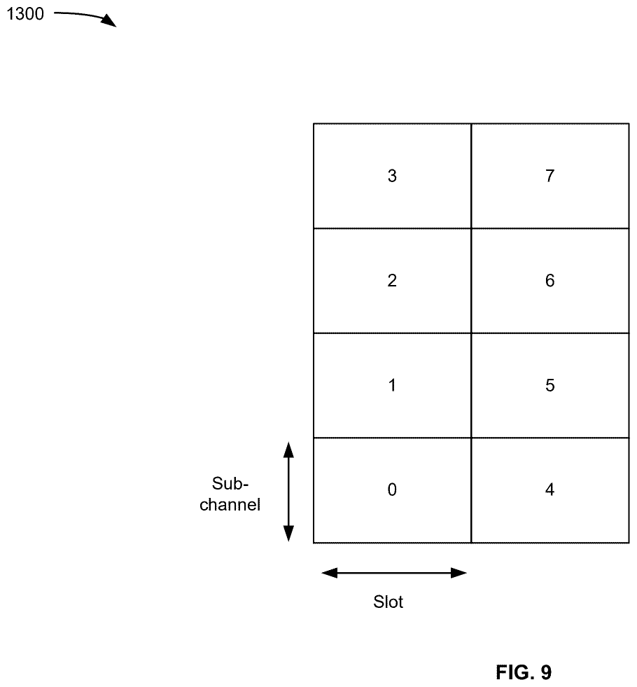

FIG. 9 illustrates an example of a resource allocation 900 for an SL RSP, in accordance with some embodiments. As described herein above, SL RSP resources can be configured for the SL RSP and can be indexed frequency first and time second or vice versa. Here, SCI can be used to indicate the resource allocation 900 such that a device can transmit or receive the SL RSP using SL RSP resource configuration and indexing.

In an example, the SCI indicates an implicit mapping between PSSCH/PSCCH resource(s) and SL RSP resource(s). For instance, the SCI may include a single bit field to indicate the transmission of the SL RSP on an associated, configured SL RSP resource. The index of the SL RSP resource can depend on the index of PSSCH/PSCCH. The PSSCH/PSCCH's index (or an index of a PSSCH/PSCCH resource) can be indicated implicitly in the SCI (e.g., the SCI indicates the location in the time domain and frequency domain of PSCCH/PSSCH, and the PSSCH/PSCCH's index can be calculated from the time-frequency location). The SL RSP resource's index can be derived from this indication. In this case, the SCI may also indicate whether or not SL RSP transmission is to occur. If so, the SL RSP resource index to be used corresponds to the PSCCH/PSSCH resource index. Otherwise, the SL RSP resource corresponding to the PSCCH/PSSCH resource index is not used.

In an example, the PSSCH/PSCCH's index can include a starting sub-channel index and a slot index. For instance, the PSSCH/PSCCH resources are indexed based on time first and frequency second (as illustrated in FIG. 9), or frequency first and time second. In the illustration of FIG. 9, a first starting PSSCH/PSCCH resource is indexed “0” and corresponds to a first slot and a first sub-channel, a second PSSCH/PSCCH resource is indexed “1” and corresponds to the same first slot but to a second sub-channel and so on, until a fourth slot indexed as “3” and corresponding to the same first slot but to the last sub-channel of the PSSCH/PSCCH. This pattern is repeated for the next second slot, where a fifth PSSCH/PSCCH resource indexed as “4” starts and corresponds to the second slot and the first sub-channel and so on until the last PSSCH/PSCCH resource indexed as “7” and corresponds to the second slot and the last sub-channel.

In an example, the mapping between an SL RSP resource index and a PSSCH/PSCCH resource index is defined such that these two indices are the same. For instance, if the SCI indicates an PSSCH/PSCCH resource index of “0,” the SL RSP resource index is implicitly indicated to also be “0.” In this example, the total number of SL RSP resources is

$$( {C}_{RE}^{comb} \cdot {N}_{symbol}^{SL RSP} ) ,$$

and this number is equal to or larger than the total number of PSSCH/PSCCH resources

$$( {N}_{period , slot}^{SL RSP} \cdot {N}_{sub - channel} ) ,$$

where

$${C}_{RE}^{comb}$$

is the combs,

$${N}_{symbol}^{SL RSP}$$

is the number of OFDM symbols used for SL RSP,

$${N}_{period , slot}^{SL RSP}$$

is the SL RSP periodicity, and N_{sub-channel} is the number of sub-channels in a resource pool.

In another example, the mapping between an SL RSP resource index and a PSSCH/PSCCH resource index is defined such that these two indices may not be the same. For instance, if the SCI indicates an PSSCH/PSCCH resource index of “1,” the SL RSP resource index is implicitly indicated to be “2.” In this example, the SL RSP resource index can be an integer multiple of the PSSCH/PSCCH resource index (e.g., “index_{SL RSP}=A·index_{PSSCH/PSCCH},” where A is the integer multiple). Accordingly, the total number of SL RSP resources

$$( {C}_{RE}^{comb} \cdot {N}_{symbol}^{SL RSP} )$$

is equal to the integer multiple of the total number of PSSCH/PSCCH resources

$$( {N}_{period , slot}^{SL RSP} \cdot {N}_{sub - channel} ) .$$

In this example, the selection of which SL RSP resource to be used can depend on a source identifier (e.g., an identifier of a transmitter device) and/or a destination identifier (e.g., an identifier of a receiver device) of the SCI in the PSSCH/PSCCH resource index.

To illustrate the use of the implicit mappings, consider the following two device procedures. The first device procedure can be implemented by a receiver device. In this procedure, the receiver device (e.g., a UE) receives sidelink PSSCH/PSCCH transmissions, where SCI indicates the future transmission of SL RSP. The receiver device determines the SL RSP index based on the slot and starting sub-channel index of PSSCH/PSCCH. The receiver device then measures the SL RSP in the determined SL RSP resource.

The second device procedure can be implemented by a transmitter device. In this procedure, the transmitter device (e.g., a UE) transmits sidelink PSSCH/PSCCH transmissions, where SCI indicates the future transmission of SL RSP. The transmitter device determines the SL RSP index based on the slot and starting sub-channel index of PSSCH/PSCCH. The transmitter device then transmits the SL RSP in the determined SL RSP resource.

In yet another example, rather than using an implicit mapping, an explicit mapping can be used. Here, the SCI can explicitly indicate and/or reserve the SL RSP resource by including a set of bits that provides this indication (rather than merely that the SL RSP is transmitted as in the case of the implicit mapping). For instance, the SCI can include an SL RSP bit field, where the bits of this field are set to bit values that indicate the reservation of an SL RSP resource having a particular index.

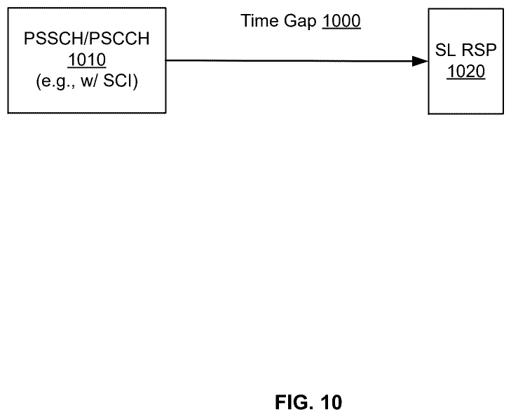

FIG. 10 illustrates an example of a time gap 1000 between a sidelink transmission (illustrated as a transmission that uses PSSCH/PSCCH 1010) and an SL RSP transmission (illustrated as a transmission that uses SL RSP 1020), in accordance with some embodiments. Generally, the sidelink transmission can include SCI that implicitly or explicitly indicates the SL RSP resource(s) that are used for the SL RSP 1020. Processing time may be needed for the receiver device to process SCI and determine the SL RSP resource(s). As such, the time gap 1000 can be used and can be equal to or larger than this processing time. In this way, the receiver device can receive the SL RSP on the SL RSP resource(s) after it has finished processing the SCI.

In an example, the receiver device can indicate the processing time and/or the desired length of the time gap 1000 to the transmitter device. This indication can be part of UE capability information. The transmitter device can then schedule the SL RSP resource(s) to occur, in the time domain, only after the time gap 1000 from the transmission of the SCI. Parameters of the time gap 1000 can be predefined or can be pre-configured or configured by a resource pool. The parameters can include any or all of a start of the time gap 1000, an end of the time gap 1000, or a time length of the time gap 1000. The time length can be defined as an integer multiple of slots (e.g., one slot, two slots, etc.).

In another example, the time gap 1000 may not be used. Instead, the SCI can be transmitted before the end of the time gap 1000. In this case, the receiver device may not receive the SL RSP on the first set of SL RSP resources. However, given the SL RSP periodicity, the receiver device can receive the SL RSP on a next set of SL RSP resources, where this set occurs in the time domain after the time gap 1000.

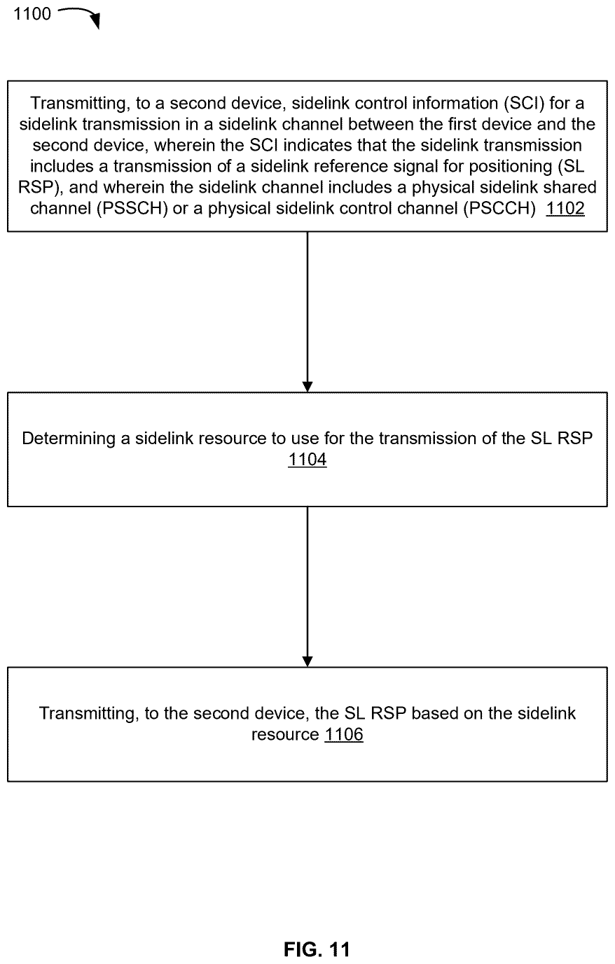

FIG. 11 illustrates an example of an operational flow/algorithmic structure 1100 for an SL RSP transmission, in accordance with some embodiments. A first device can implement the operational flow/algorithmic structure 1100, where this first device can be a transmitter device in sidelink communications, such as the UE 104 or 106, or components thereof, for example, processors 1404.

In an example, the operational flow/algorithmic structure 1100 includes, at 1102, transmitting, to a second device, SCI for a sidelink transmission in a sidelink channel between the first device and the second device, wherein the SCI indicates that the sidelink transmission includes a transmission of an SL RSP, and wherein the sidelink channel includes a PSSCH or a PSCCH. For instance, the SCI can indicate an index associated with the PSSCH and/or the PSCCH and can include a single bit field indicating that the SL RSP is transmitted. In this illustration, an implicit mapping between the explicitly indicated index and an index of an SL RSP resource is used to determine the SL RSP resource. This SL RSP resource is used for the transmission of the SL RSP. In another illustration, rather an implicit mapping, an explicit mapping is used. In this case, the SCI can include an SL RSP bit field that uses multiple bits to indicate the SL RSP resource. In both cases, prior to transmitting the SCI, the first device may have transmitted configuration information that configures the second device to use SL RSP resources and such resources can be indexed frequency first and time second or vice versa.

In an example, the operational flow/algorithmic structure 1100 includes, at 1104, determining a sidelink resource to use for the transmission of the SL RSP. For instance, the sidelink resource includes an SL RSP resource that meets the configuration information and that may occur, in the time domain, after a time gap from the transmission of the transmission of the SCI.

In an example, the operational flow/algorithmic structure 1100 includes, at 1106, transmitting, to the second device, the SL RSP based on the sidelink resource. For instance, the SL RSP resource carry content that can be used to measure the SL RSP. In the case of multiple OFDM symbols used in the SL RSP resource, the content can be repeated across the OFDM symbols, such that a first OFDM symbol (or a first set of such symbols) can be used for AGC and remaining OFDM symbol(s) can be used for SL RSP measurements.

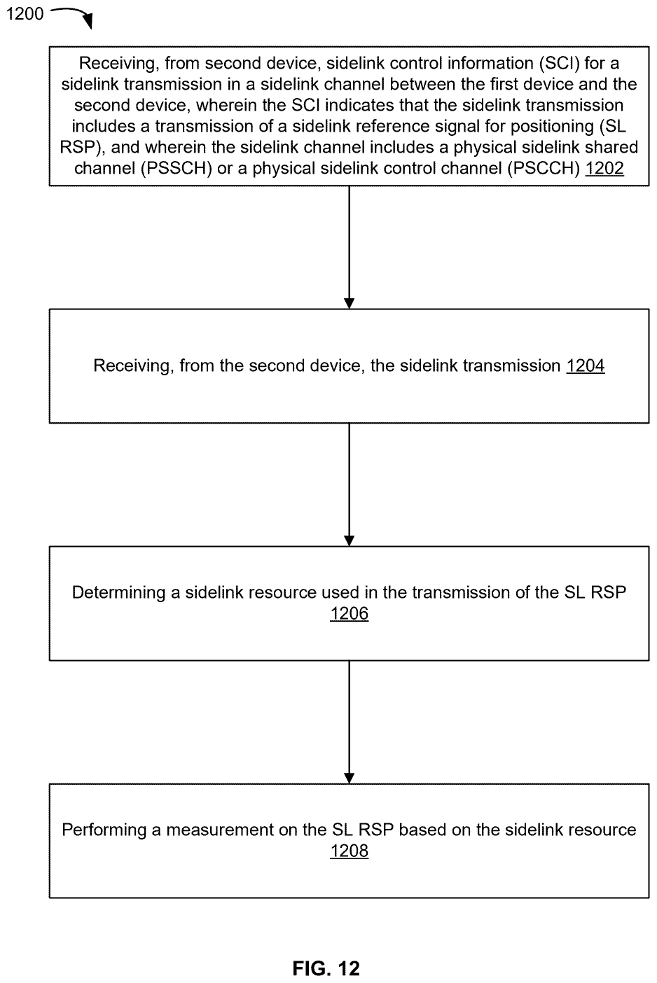

FIG. 12 illustrates an example of an operational flow/algorithmic structure 1200 for an SL RSP reception, in accordance with some embodiments. A first device can implement the operational flow/algorithmic structure 1200, where this first device can be a receiver device in sidelink communications, such as the UE 104 or 106, or components thereof, for example, processors 1404.

In an example, the operational flow/algorithmic structure 1200 includes, at 1202, receiving, from second device, SCI for a sidelink transmission in a sidelink channel between the first device and the second device, wherein the SCI indicates that the sidelink transmission includes a transmission of an SL RSP, and wherein the sidelink channel includes a PSSCH or a PSCCH. For instance, the SCI can indicate an index associated with the PSSCH and/or the PSCCH and can include a single bit field indicating that the SL RSP is transmitted. In this illustration, an implicit mapping between the explicitly indicated index and an index of an SL RSP resource is used to determine the SL RSP resource. This SL RSP resource is used for the transmission of the SL RSP. In another illustration, rather an implicit mapping, an explicit mapping is used. In this case, the SCI can include an SL RSP bit field that uses multiple bits to indicate the SL RSP resource. In both cases, prior to transmitting the SCI, the first device may have received configuration information that configures the first device to determine SL RSP resources used for SL RSP transmissions and such resources can be indexed frequency first and time second or vice versa.

In an example, the operational flow/algorithmic structure 1200 includes, at 1204, receiving, from the second device, the sidelink transmission. For instance, the first device receives data on the PSSCH or control information on the PSCCH. In addition to data and/or control information being received, the received sidelink transmission can include the transmission of the SL RSP.

In an example, the operational flow/algorithmic structure 1200 includes, at 1206, determining a sidelink resource used in the transmission of the SL RSP. For instance, the sidelink resource includes an SL RSP resource that meets the configuration information and that may occur, in the time domain, after a time gap from the transmission of the transmission of the SCI. The index of this SL RSP resource can be determined implicitly or explicitly from the SCI.

In an example, the operational flow/algorithmic structure 1200 includes, at 1208, performing a measurement on the SL RSP based on the sidelink resource. For instance, measurements that use the SL RSP resource are performed according to one or more localization techniques. These techniques can include timing-based techniques, such as time of arrival (ToA), time difference of arrival (TDoA), or round-trip time (RTT) and/or angle-based techniques, such as angle of arrival (AoA).

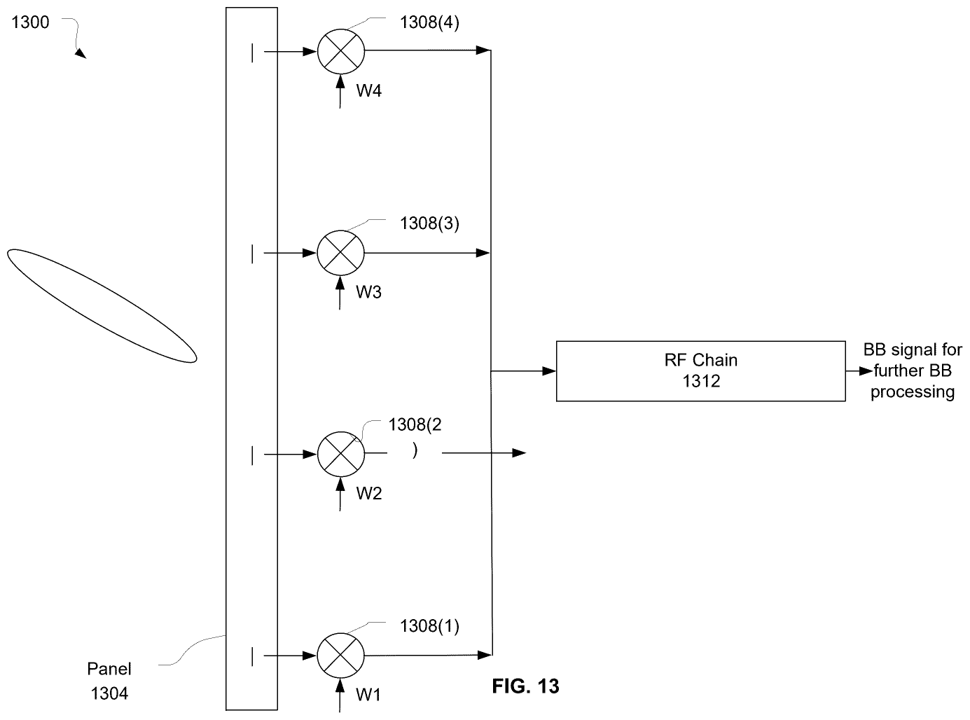

FIG. 13 illustrates receive components 1300 of the UE 144, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1)-1308(4) may be coupled with a radio-frequency (RF) chain 1312. The RF chain 1312 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1308(1)-1308(4) to provide a receive beam at the antenna panel 1304. These BF weights may be determined based on the channel-based beamforming.

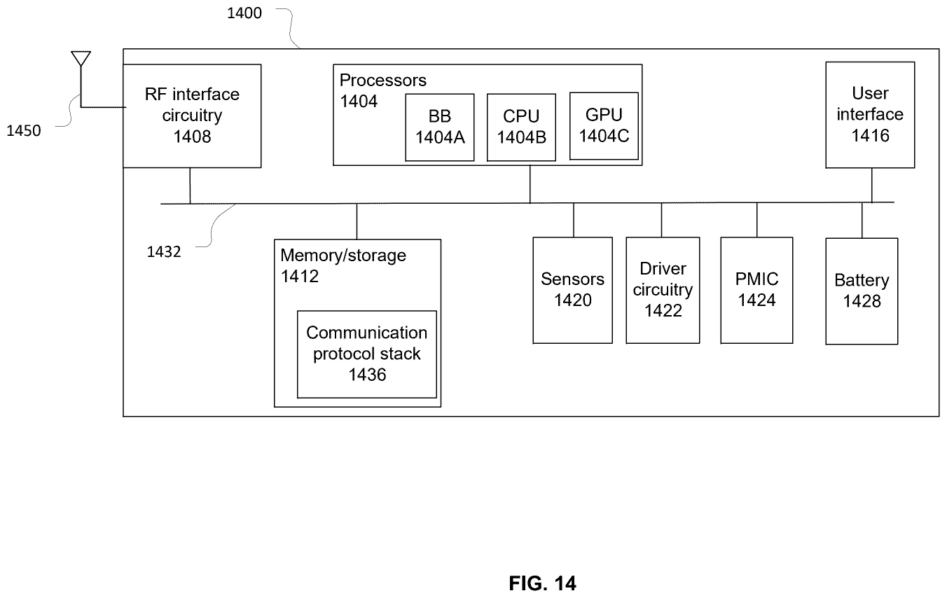

FIG. 14 illustrates a UE 1400, in accordance with some embodiments. The UE 1400 may be similar to and substantially interchangeable with UE 104 or 106 of FIG. 1.

Similar to that described above with respect to UE 144, the UE 1400 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry, such as baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1450 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1450.

In various embodiments, the RF interface circuitry 1408 may be configured to transmit/receive signals in a manner compatible with NR access technologies.

The antenna 1450 may include a number of antenna elements that each convert electrical signals into radio waves to travel through the air and to convert received radio waves into electrical signals. The antenna elements may be arranged into one or more antenna panels. The antenna 1450 may have antenna panels that are omnidirectional, directional, or a combination thereof to enable beamforming and multiple input, multiple output communications. The antenna 1450 may include microstrip antennas, printed antennas fabricated on the surface of one or more printed circuit boards, patch antennas, phased array antennas, etc. The antenna 1450 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations, such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

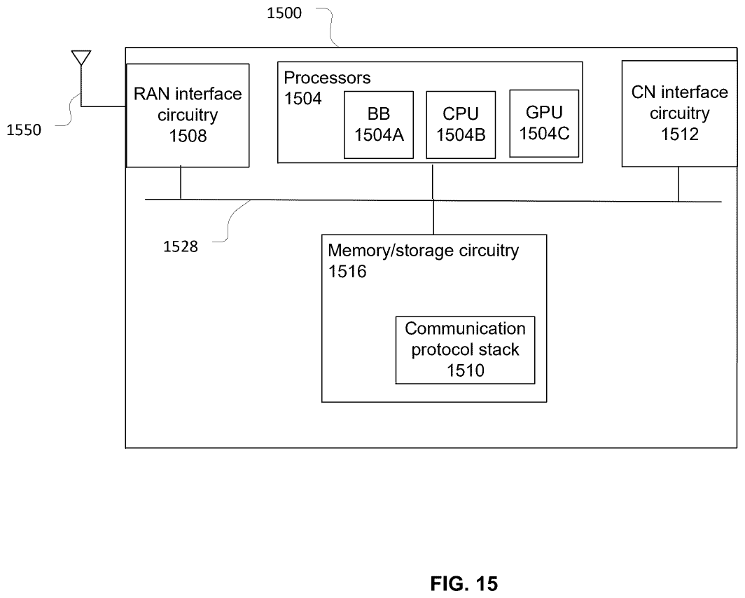

FIG. 15 illustrates a gNB 1500, in accordance with some embodiments. The gNB 1500 may be similar to and substantially interchangeable with the gNB 108 of FIG. 1.

The gNB 1500 may include processors 1504, RAN interface circuitry 1508, core network (CN) interface circuitry 1512, and memory/storage circuitry 1516.

The components of the gNB 1500 may be coupled with various other components over one or more interconnects 1528.

The processors 1504, RAN interface circuitry 1508, memory/storage circuitry 1516 (including communication protocol stack 1510), antenna 1550, and interconnects 1528 may be similar to like-named elements shown and described with respect to FIG. 14.

The CN interface circuitry 1512 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method implemented by a first device, the method comprising: transmitting, to a second device, sidelink control information (SCI) for a sidelink transmission in a sidelink channel between the first device and the second device, wherein the SCI indicates that the sidelink transmission includes a transmission of a sidelink reference signal for positioning (SL RSP), and wherein the sidelink channel includes a physical sidelink shared channel (PSSCH) or a physical sidelink control channel (PSCCH); determining a sidelink resource to use for the transmission of the SL RSP; and transmitting, to the second device, the SL RSP based on the sidelink resource.

Example 2 includes a method implemented by a first device, the method comprising: receiving, from a second device, sidelink control information (SCI) for a sidelink transmission in a sidelink channel between the first device and the second device, wherein the SCI indicates that the sidelink transmission includes a transmission of a sidelink reference signal for positioning (SL RSP), and wherein the sidelink channel includes a physical sidelink shared channel (PSSCH) or a physical sidelink control channel (PSCCH); receiving, from the second device, the sidelink transmission; determining a sidelink resource used in the transmission of the SL RSP; and performing a measurement on the SL RSP based on the sidelink resource.

Example 3 includes the method of any preceding example 1-2, wherein the SCI includes a bit field that includes a plurality of bits indicating the sidelink resource for the SL RSP, and wherein the sidelink resource is determined based on the plurality of bits.

Example 4 includes the method of any preceding example 1-2, wherein the SL RSP is transmitted after a time gap from the transmitting of the SCI, wherein the time gap is pre-configured or configured by a resource pool associated with the sidelink transmission or is predefined.

Example 5 includes the method of any preceding example 1-2, wherein the SCI includes a bit field that indicates a PSSCH resource or a PSCCH resource for the sidelink transmission, and wherein the sidelink resource is determined based on the bit field.

Example 6 includes the method of any preceding example 1-2, wherein the method further comprises: determining, based on the SCI, a first resource index a PSSCH resource or a PSCCH resource of the sidelink transmission; and determining, based on the first resource index, a second resource index of the sidelink resource, wherein the SL RSP is transmitted based on the second resource index.

Example 7 includes the method of example 6, wherein the PSSCH resource or the PSCCH resource is indexed based on time first and frequency second or based on frequency first and time second.

Example 8 includes the method of example 6, wherein the second resource index is the same as the first resource index.

Example 9 includes the method of example 8, wherein the sidelink transmission uses a total number of SL RSP resources that is equal or larger than a total number of PSSCH resources or PSCCH resources.

Example 10 includes the method of example 6, wherein the second resource index is an integer multiple of the first resource index.

Example 11 includes the method of example 10, wherein the sidelink transmission uses a total number of SL RSP resources that is equal or larger than an integer multiple of a total number of PSSCH resources or PSCCH resources.

Example 12 includes the method of any preceding example 1-10, wherein the sidelink resource includes combed resource elements in an orthogonal frequency division multiplexing (OFDM) symbol.

Example 13 includes the method of any preceding example 1-10, wherein the sidelink resource includes a plurality of resource elements that are distributed across a bandwidth or a portion of the bandwidth associated with the sidelink transmission.

Example 14 includes the method of any preceding example 1-10, wherein the sidelink resource includes combed resource a plurality of orthogonal frequency division multiplexing (OFDM) symbols that are contiguous or non-contiguous in the time domain.

Example 15 includes the method of any preceding example 1-10, wherein the sidelink resource is indexed based on time first and frequency second or on frequency first and time second.

Example 16 includes the method of any preceding example 1-15, wherein the method further comprises: transmitting, to the second device, first configuration information that indicates a resource configuration usable for the SL RSP, wherein the first configuration information is separate from second configuration information for the PSSCH or the PSCCH.

Example 17 includes the method of example 16, wherein the first configuration information includes a first bitmap that indicates that a first slot in a resource pool is usable for the SL RSP, wherein the second configuration information includes a second bitmap that indicates that a second slot in the resource pool is usable for PSSCH data or PSCCH control, and wherein the first bitmap and the second bitmap have a same size.

Example 18 includes the method of any preceding example 1-15, wherein the method further comprises: transmitting, to the second device, configuration information that jointly indicates a resource configuration usable for the SL RSP and for the PSSCH or the PSCCH.

Example 19 includes the method of example 18, wherein the configuration information includes a bitmap that indicates whether a slot in a resource pool is usable for any of the SL RSP, the PSSCH, or the PSCCH or not.

Example 20 includes the method of any preceding example 1-15, wherein the method further comprises: transmitting, to the second device, configuration information indicating that, in a resource pool, a slot usable for the PSSCH or the PSCCH is dedicated to sidelink device-to-device positioning.

Example 21 includes the method of example 20, wherein the slot includes a first orthogonal frequency division multiplexing (OFDM) symbol usable for the SL RSP.

Example 22 includes the method of example 21, wherein the slot includes a second OFDM symbol usable for automatic gain control (AGC), wherein the second OFDM symbol precedes the first OFDM symbol.

Example 23 includes the method of example 20, wherein the slot includes a plurality of orthogonal frequency division multiplexing (OFDM) symbol groups usable for sidelink device-to-device positioning, wherein each one of the plurality of OFDM symbol groups includes one or more OFDM symbols, and wherein at least two of the OFDM symbols are separated by one or more gap symbols in the slot.

Example 24 includes the method of any preceding example 1-15, wherein the method further comprises: transmitting, to the second device, configuration information indicating that, in a resource pool, a slot includes a first orthogonal frequency division multiplexing (OFDM) symbol usable for the PSSCH or the PSCCH and a second OFDM symbol is usable for the SL RSP.

Example 25 includes the method of example 24, wherein the slot includes one or more slot gaps that separate the first OFDM symbol and the second OFDM symbol.

Example 26 includes the method of example 24, wherein configuration information indicates that the sidelink resource to use for the transmission of the SL RSP shares is frequency division multiplexed with another sidelink resource to use for a physical sidelink feedback channel (PSFCH).

Example 27 includes the method of example 24, wherein configuration information indicates that the sidelink resource to use for the transmission of the SL RSP shares is time division multiplexed with another sidelink resource to use for a physical sidelink feedback channel (PSFCH).

Example 28 includes a device comprising means to perform one or more elements of a method described in or related to any of the examples 1-27.

Example 29 includes one or more non-transitory computer-readable media comprising instructions to cause a device, upon execution of the instructions by one or more processors of the device, to perform one or more elements of a method described in or related to any of the examples 1-27.

Example 30 includes a device comprising logic, modules, or circuitry to perform one or more elements of a method described in or related to any of the examples 1-27.

Example 31 includes a device comprising: one or more processors and one or more computer-readable media comprising instructions that, when executed by the one or more processors, cause the one or more processors to perform one or more elements of a method described in or related to any of the examples 1-27.

Example 32 includes a system comprising means to perform one or more elements of a method described in or related to any of the examples 1-27.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

Applicant hereby claims:

1. A method comprising:
generating sidelink control information (SCI) for a sidelink transmission in a sidelink channel with a device, wherein the SCI indicates that the sidelink transmission includes a transmission of a sidelink reference signal for positioning (SL RSP), and wherein the sidelink channel includes a physical sidelink shared channel (PSSCH) or a physical sidelink control channel (PSCCH);
determining a sidelink resource to use for the transmission of the SL RSP; and
generating, for the transmission to the device, the SL RSP based on the sidelink resource.

2. The method of claim 1, wherein the SCI includes a bit field that includes a plurality of bits indicating the sidelink resource for the SL RSP, and wherein the sidelink resource is determined based on the plurality of bits.

3. The method of claim 1, wherein the SL RSP is transmitted after a time gap from the transmission of the SCI, wherein the time gap is pre-configured or configured by a resource pool associated with the sidelink transmission or is predefined.

4. The method of claim 1, further comprising:
determining, based on the SCI, a first resource index of a PSSCH resource or a PSCCH resource of the sidelink transmission; and
determining, based on the first resource index, a second resource index of the sidelink resource, wherein the SL RSP is transmitted based on the second resource index.

5. The method of claim 2, wherein the second resource index is the same as the first resource index.

6. An apparatus comprising:
processing circuitry to:
process sidelink control information (SCI) for a sidelink transmission in a sidelink channel with a device, wherein the SCI indicates that the sidelink transmission includes a transmission of a sidelink reference signal for positioning (SL RSP), and wherein the sidelink channel includes a physical sidelink shared channel (PSSCH) or a physical sidelink control channel (PSCCH);
process information of the sidelink transmission;
determine a sidelink resource used in the transmission of the SL RSP; and
perform a measurement on the SL RSP based on the sidelink resource; and interface circuity coupled with the processing circuitry to enable communication.

7. The apparatus of claim 6, wherein the sidelink resource includes combed resource elements in an orthogonal frequency division multiplexing (OFDM) symbol.

8. The apparatus of claim 6, wherein the sidelink resource includes a plurality of resource elements that are distributed across a bandwidth or a portion of the bandwidth associated with the sidelink transmission.

9. The apparatus of claim 6, wherein the sidelink resource includes combed resource elements in a plurality of orthogonal frequency division multiplexing (OFDM) symbols that are contiguous or non-contiguous in the time domain.

10. One or more computer-readable storage media storing instructions that, upon execution, cause operations comprising:
generating sidelink control information (SCI) for a sidelink transmission in a sidelink channel with a device, wherein the SCI indicates that the sidelink transmission includes a transmission of a sidelink reference signal for positioning (SL RSP), and wherein the sidelink channel includes a physical sidelink shared channel (PSSCH) or a physical sidelink control channel (PSCCH);
determining a sidelink resource to use for the transmission of the SL RSP; and
generating, for the transmission to the device, the SL RSP based on the sidelink resource.

11. The one or more computer-readable storage media of claim 10, wherein the operations further comprise:
transmitting, to the device, first configuration information that indicates a resource configuration usable for the SL RSP, wherein the first configuration information is separate from second configuration information for the PSSCH or the PSCCH.

12. The one or more computer-readable storage media of claim 11, wherein the first configuration information includes a first bitmap that indicates that a first slot in a resource pool is usable for the SL RSP, wherein the second configuration information includes a second bitmap that indicates that a second slot in the resource pool is usable for PSSCH data or PSCCH control, and wherein the first bitmap and the second bitmap have a same size.

13. The one or more computer-readable storage media of claim 10, wherein the operations further comprise:
generating, for transmission to the device, configuration information that jointly indicates a resource configuration usable for the SL RSP and for the PSSCH or the PSCCH.

14. The one or more computer-readable storage media of claim 13, wherein the configuration information includes a bitmap that indicates whether a slot in a resource pool is usable for any of the SL RSP, the PSSCH, or the PSCCH or not.

15. The one or more computer-readable storage media of claim 10, wherein the operations further comprise:
generating, for transmission to the device, configuration information indicating that, in a resource pool, a slot usable for the PSSCH or the PSCCH is dedicated to sidelink device-to-device positioning.

16. The one or more computer-readable storage media of claim 15, wherein the slot includes a first orthogonal frequency division multiplexing (OFDM) symbol usable for the SL RSP.

17. The one or more computer-readable storage media of claim 16, wherein the slot includes a second OFDM symbol usable for automatic gain control (AGC), wherein the second OFDM symbol precedes the first OFDM symbol.

18. The one or more computer-readable storage media of claim 15, wherein the slot includes a plurality of orthogonal frequency division multiplexing (OFDM) symbol groups usable for sidelink device-to-device positioning, wherein each one of the plurality of OFDM symbol groups includes one or more OFDM symbols, and wherein at least two of the OFDM symbols are separated by one or more gap symbols in the slot.

19. The one or more computer-readable storage media of claim 10, wherein the operations further comprise:
generating, for transmission to the device, configuration information indicating that, in a resource pool, a slot includes a first orthogonal frequency division multiplexing (OFDM) symbol usable for the PSSCH or the PSCCH and a second OFDM symbol is usable for the SL RSP.

20. The one or more computer-readable storage media of claim 19, wherein the slot includes one or more slot gaps that separate the first OFDM symbol and the second OFDM symbol.
